(19) United States
(12) Patent Application Publication
(10) Pub. No.: US 2003/0084298 A1
(43) Pub. Date: May 1, 2003

(54) Method for efficient hashing of digital content

(76) Inventors: Thomas S. Messerges, Schaumburg, IL (US); Ezzat A. Dabbish, Cary, IL (US); Larry Puhl, West Dundee, IL (US); Douglas A. Kuhlman, Elgin, IL (US)

Correspondence Address: MOTOROLA, INC., 1303 EAST ALGONQUIN ROAD, IL01/3RD, SCHAUMBURG, IL, 60196

(21) Appl. No.: 10/028,164

(22) Filed: Oct. 25, 2001

(51) Int. Cl. H04L 9/00

(52) U.S. Cl. 713/176

(57) ABSTRACT

A method of authenticating digital content of a digital object. Content is divided into portions or chunks. A chunk hash of each chunk is calculated to provide chunk hashes that are stored as entries in a hash table. The chunk hash entries of the hash table are in turn hashed to create an overall hash of the hash table. Verification of the content first includes determining whether a recalculated overall hash of the hash table matches the previously calculated overall hash of the hash table. If the recalculated overall hash does match, this indicates that the hash table is authenticated and that the authenticity of the individual chunks can be verified. Verification of the authenticity of an individual chunk, which may be performed concurrently with the processing of the individual chunk, allows the content of the digital object to be incrementally rendered, chunk by chunk, resulting in a much faster and efficient rendering of the verified digital content.

### FIELD OF THE INVENTION

The present invention relates generally to communication systems and more specifically to digital rights management (DRM) related to accessing and processing digital information content.

### BACKGROUND OF THE INVENTION

The popularity of digital content, such as MP3 music files, electronic games, DVD and MPEG movies, audio books, videos, electronic games, video clips, business data such as electronic mail and documents, is growing at a tremendous rate. Portable, wireless devices like pagers and mobile phones stand poised to make access to this digital content easier than ever. Content owners and providers, however, are concerned that the advent of such new devices will make digital content more susceptible to illicit copying and distribution. In order to avoid widespread piracy of valuable digital content, therefore, there is a need for secure methods for the distribution of electronic content that is not subject to abuse.

Digital Rights Management (DRM) is a popular phrase used to describe the protection of rights and the management of usage rules related to accessing and processing digital information. These rights and rules govern various aspects of a digital object, such as who owns the object, how and when an object can be accessed and/or copied, and how much an object may cost. Content owners and providers hope to use a secure, tamper-resistant Digital Rights Management system, impervious to attack by would-be hackers, to enforce the rules associated with a digital object and to protect the integrity of the digital object. It is important that hackers not be able to overcome the enforcement of these rules or alter the content associated with these rules. In particular, hackers should not be able to alter digital objects or their rules without detection.

The problem of protecting digital objects and their associated usage rules is not straightforward. Hackers will likely have direct access to the digital objects and the rules. Objects and rules stored on a disk drive of a personal computer (PC), for instance, may be readily accessed by an editing program. Since hackers may be able to easily change bits in the digital objects or associated rules, the Digital Rights Management system must be able to detect and report any such changes. This problem is exacerbated by the often large size of a digital object. Consider, for example, that compressed digital songs are typically 3 to 5 Mbytes and that DVD movies can be orders of magnitude larger. Verifying the integrity of such a large digital object can be very time consuming and inefficient.

An approach that has been taken to authenticate the integrity of a digital object, whose component parts of content and usage rules may together be referred to as a content package, uses a digital signature to sign a cryptographic hash of the object. The following standard cryptography textbooks provide background information on data authentication solutions, including hashing, and are herein incorporated by reference: “Cryptography: Theory and Practice,” by Douglas R. Stinson, CRC Press, 1995; “Applied Cryptography,” by Bruce Schneier, 2^{nd} Edition, John Wiley & Sons, 1996.

Referring now to FIG. 1, a pictorial representation 10 of one embodiment of this prior art approach is illustrated. Content 12 is encrypted by an encryption device 14 to provide a content package 16 having encrypted content 18 and a certificate of authenticity 20. In a preferred embodiment, the content is encrypted with a secret key to protect it from being used by anyone other than an authorized user. An authorized user would probably be a content purchaser, but there are other possibilities. The encrypted content 18 is next cryptographically hashed to produce hash value Hash(EC), which is next placed into the certificate of authenticity CCert 20 as indicated. The CCert certificate of authenticity can also contain additional information, such as the content's usage rules Rules, along with the content decryption key encrypted with the content purchaser's unit public key KuPub, or other important information. Finally, a trusted authority uses its private key CSK to digitally sign the certificate 20.

There are also slightly different methods of hashing and encrypting content in the art. One of these is to first hash the content, append the hash to the content, and then encrypt the entire package. This provides excellent integrity checking, while the authenticity is harder to establish. Another method is to hash the content before encryption and to put that hash value into the certificate. The content is also encrypted. Authenticity of the content can only be verified after the content has been decrypted.

Flow chart 30 of FIG. 2 illustrates this binding of the encrypted content to a rules certificate. At Block 32, the content is encrypted. At Block 34, the encrypted content is hashed to produce a hash value Hash(EC). Next at Block 36, hash value Hash(EC) is placed into CCert certificate of authenticity and a trusted authority signs CCert certificate at Block 38.

Verifying the authenticity of a content package is relatively straightforward and is illustrated in flow 40 of FIG. 3. At Block 42, the digital signature of the certificate of authenticity CCert is verified. If the digital signature is valid, as determined at Decision Block 44, then the next step, at Block 46, is to recalculate the hash of the encrypted content so that it can be compared to the originally calculated hash Hash(EC) that is part of the certificate CCert. This occurs at Decision Block 48. If the recalculated hash matches Hash(EC), then the content package is authenticated, at Block 50, and the content 12 can be decrypted and rendered. If the recalculated hash does not match Hash(EC), then the content package is not authenticated, as shown at Block 54.

A major shortcoming of this approach is that it requires that the hash of the entire content must be calculated before the digital object can be rendered. This can be prohibitively time consuming. As previously stated, the size of many digital objects, such as digital movies and songs, can be quite large. Consider, for example, that the estimated time to compute the SHA1 hash of a typical MP3 song, when using a 16 MHz MCore processor, is 15 to 20 seconds. A user of a content rendering device, such as a CD or DVD player, however, expects rendering to being almost immediately upon selecting one or more digital objects.

In other possible prior art embodiments, it is still the case that the hash of the entire content must be calculated before the content is authenticated. In these instances of the prior art, computing a hash is an all-or-nothing proposition. That is, the entire hash has to be calculated before any useful information is retrieved.

In light of the foregoing, it can be seen that there is thus an unmet need in the art to provide a more efficient method to detect changes in digital objects and their associated usage rules.

### BRIEF DESCRIPTION OF THE DRAWINGS

The novel features believed characteristic of the invention are set forth in the claims. The invention itself, however, as well as a preferred mode of use, and further objects and advantages thereof, will best be understood by reference to the following detailed description of an illustrative embodiment when read in conjunction with the accompanying drawings, wherein:

FIG. 1 is a block diagram illustrating a method for binding content to a rules certificate, in accordance with the prior art.

FIG. 2 is a flow illustrating a method of binding content to a rules certificate, in accordance with the prior art.

FIG. 3 is a flow illustrating a method for verifying authenticity of a content package, in accordance with the prior art.

FIG. 4 is a flow illustrating the overall method of authenticating digital content, in accordance with a preferred embodiment of the present invention.

FIG. 5 is a flow that illustrates a method of binding content to a rules certificate, in accordance with the present invention.

FIG. 6 is a block diagram further illustrating the method of binding content to a rules certificate, in accordance with the present invention.

FIG. 7 is a flow that illustrates a method of verifying the hash table of a content package, in accordance with the preferred embodiment of the present invention.

FIG. 8 is a block diagram further illustrating the method of verifying the hash table of a content package, in accordance with the present invention.

FIG. 9 is a flow that illustrates a method of verifying the hash of individual chunks or portions of encrypted content, in accordance with the present invention.

FIG. 10 is a block diagram further illustrating the method of verifying the hash of individual chunks of encrypted content, in accordance with the present invention.

FIG. 11 is a system block diagram illustrating how the generation and verification processes of the present invention can be used to ensure that an authorized user device receives authenticated digital content, in accordance with the present invention.

FIG. 12 is a block diagram illustrating how multiple layers of hash tables can be used in series for very large content, in accordance with the present invention.

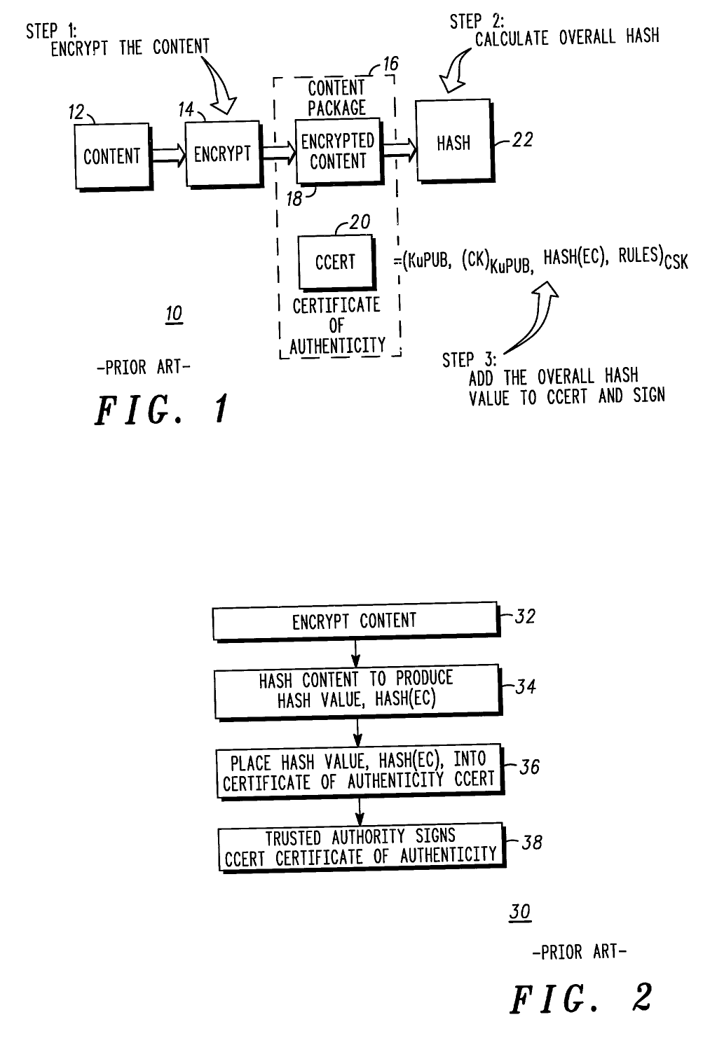

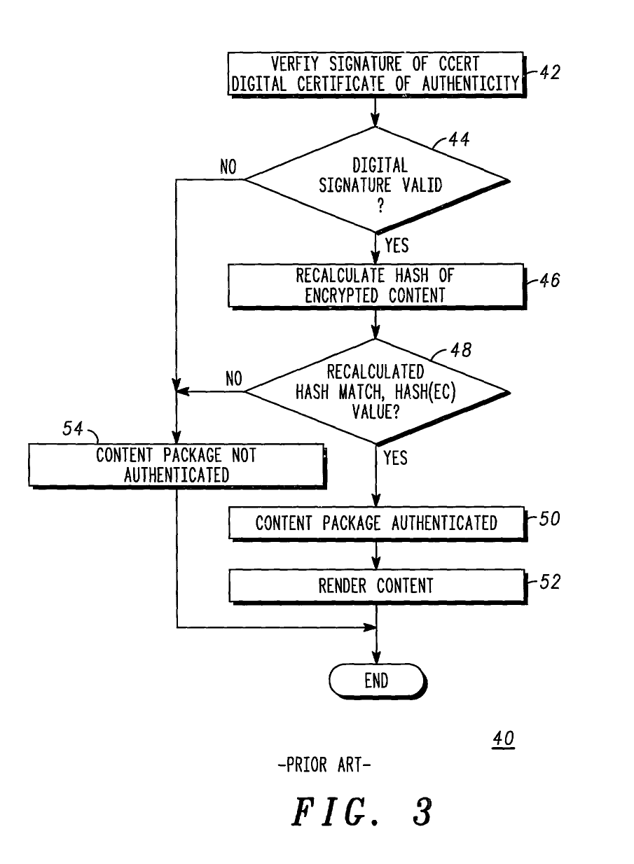

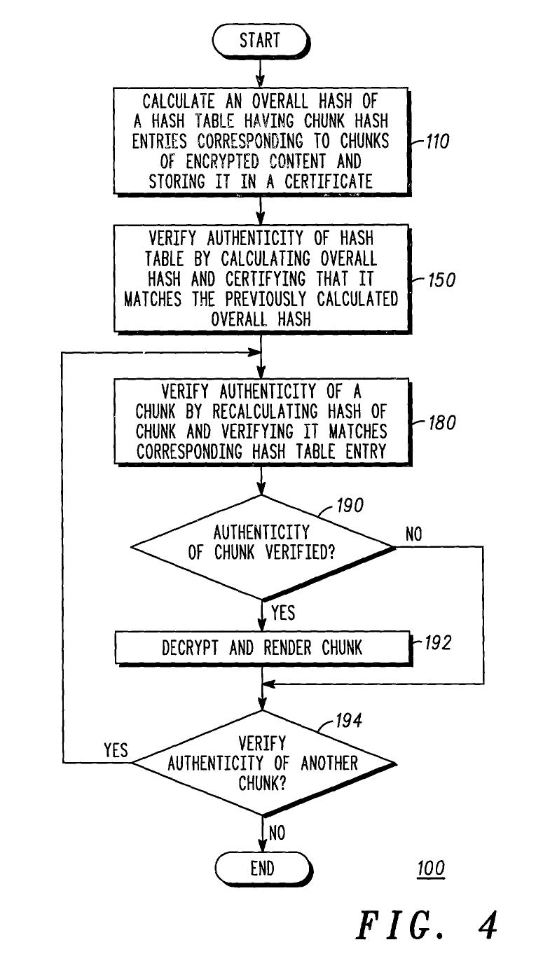

### DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawing.

The present invention provides an efficient method for detecting changes in digital objects and their associated usage rules, and is particularly applicable to large digital objects in which verification that the object has not changed can be a very time consuming process otherwise. The present invention provides an efficient method to detect changes in digital objects and their associated usage rules. Rather than having to calculate the hash of the entire content package of a digital object before rendering content, during verification the hash is calculated incrementally and verified as the content is being rendered.

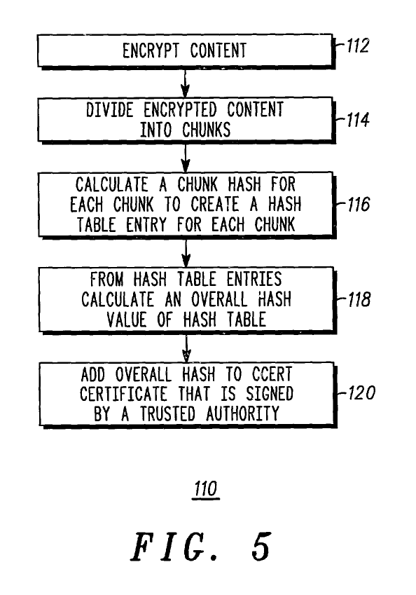

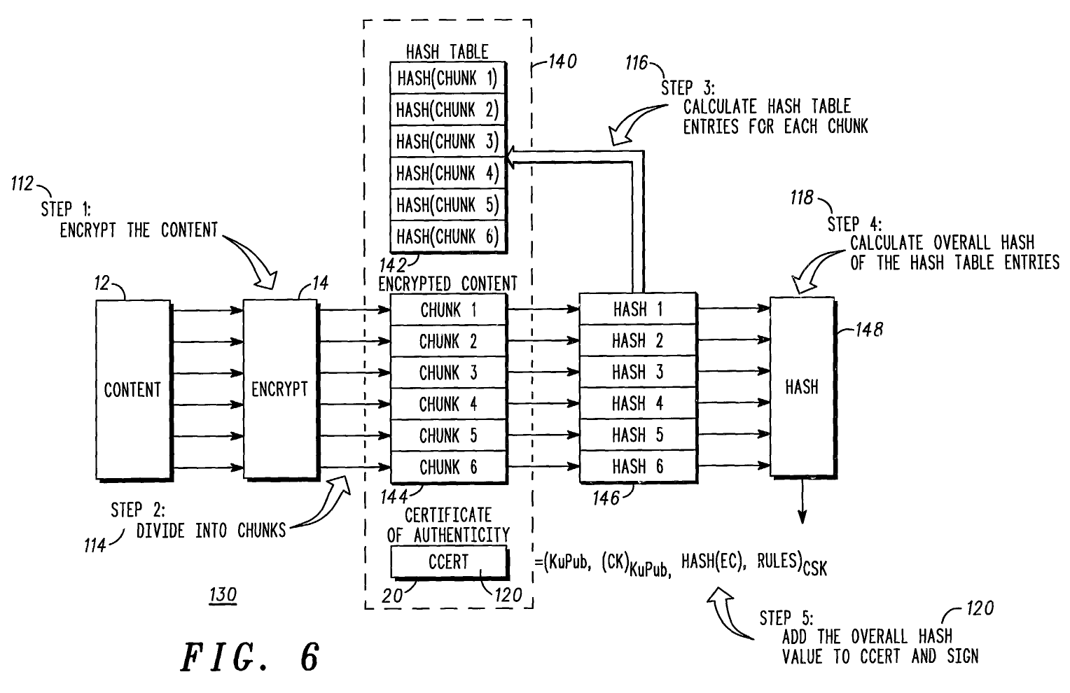

Referring to FIG. 4, an overall flow 100 of the methodology of the preferred embodiment of the present invention is shown. At Block 110, an overall hash of a hash table, having a number of chunk hash entries corresponding to chunks of encrypted content, is calculated. As used herein, the term “chunk” refers to some portion, part, or section of the content. As will be described later, the chunks are obtained by dividing the encrypted content into subparts, portions, parts or sections of the content; these chunks or portions need not necessarily by of the same length or size. Some of the many possible methods of dividing content into chunks include, but are not limited to, breaking the content into fixed length chunks, using content subtext to divide the content into chunks, and making chunk lengths dependent upon the position of the chunks within the content. Hashes of the chunks are stored as chunk hash entries of the hash table, and will be described herein in conjunction with FIGS. 5-6.

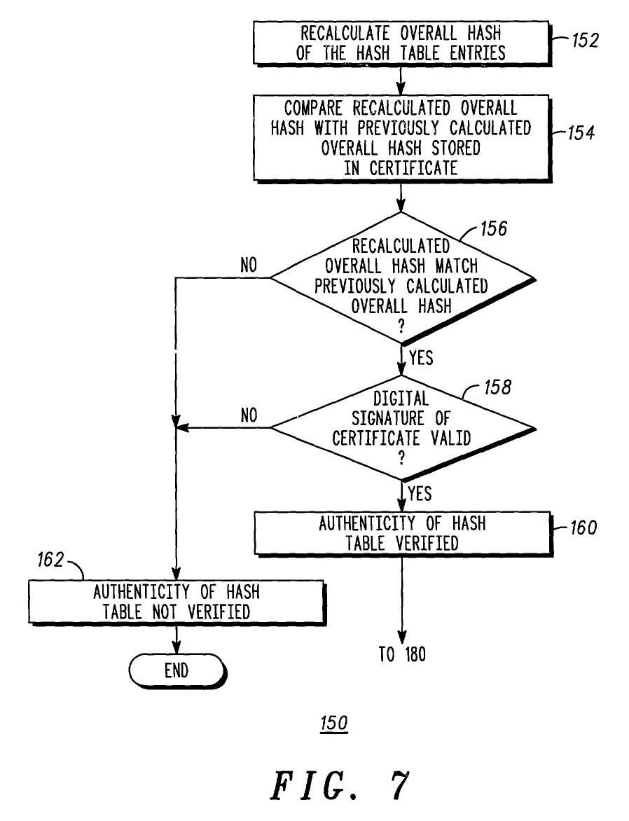

Next, at some later time, verification of the hash table and subsequent verification of the chunks of the encrypted content if the hash table proves out, is performed. At Block 150, the authenticity of the hash table is verified by recalculating the overall hash of the hash table and verifying that it matches a previously calculated overall hash of the hash table. Next, assuming that the authenticity of the hash table has been proved at Block 150, at Blocks 180 and 190 the authenticity of a chunk of the encrypted content is verified. Authentication of a chunk allows that chunk to be immediately decrypted and rendered at Block 192 without the prior art requirement that the hash of entire content package be calculated first. For encrypted content, decryption of the chunk may occur in parallel to the hashing of the chunk in order to facilitate faster rendering of the chunk. Decision Block 194 ensures that every chunk to be authenticated is indeed authenticated. The two-stage verification process of Blocks 150 and 180 will be described in more detail in conjunction with FIGS. 7-10.

Referring now to FIG. 6, Block 110 of FIG. 4 for calculating an overall hash of a hash table having chunk hash entries corresponding to chunks of encrypted content is further described. At Block 112, the content is optionally encrypted, if so desired, and then divided into subparts or chunks at Block 114. At Block 116, a chunk hash is calculated for each chunk and stored in a hash table to create a plurality of hash table entries. From these hash table entries, which are simply the chunk hashes, an overall hash value of the hash table is calculated at Block 118. At Block 120, this overall hash value of the hash table is added to a certificate that is signed by a trusted authority.

It is also noted that those skilled in the art recognize that a digital signature is often viewed to include a hash function, thus the digital signature of the hash table data to create a certificate of authenticity can be performed directly on the hash table data without the intermediate step of calculating an overall hash. Of course, this scheme still encompasses the use of an overall hash, in this case, however, the overall hash is viewed as part of the digital signature scheme and not as a separate component. Thus, alternative approaches such as this one are essentially analogous and are considered to be part of the present invention.

This approach is illustrated pictorially in conjunction with FIG. 6. Content 12 is encrypted by an encryption element 14, corresponding to Block 112. The encrypted content is divided into subparts or chunks 144 (shown as Chunk1, Chunk2, Chunk3, Chunk4, Chunk5, Chunk6) that, together with hash table 142 and CCert rules certificate 20, form the secure content package 140; this corresponds to Block 114 of FIG. 5. Next, cryptographic hashes 146 of each chunk are calculated and stored as chunk hash table entries in hash table 142; this corresponds to Block 116 of FIG. 5. The overall hash 148 of the hash table entries, denoted as Hash(EC), is calculated at Block 118 and at Block 120 the overall hash value is placed into certificate of authenticity CCert and the CCert certificate is digitally signed by a trusted authority.

Next, the verification process of the present invention will be described in FIGS. 7-10. The flow of FIG. 7 expands upon the first step of verification, verification of the hash table 142, shown at Block 150 in FIG. 4. At Block 152, the overall hash of the hash table entries is recalculated. This recalculated overall hash value is then compared with the previously calculated overall hash Hash(EC) that is part of the CCert certificate of authenticity. If the recalculated overall hash matches the overall hash of the certificate and if the digital signature of the CCert certificate is valid, as determined at Decision Blocks 154, 156 and 158, then the hash table and its binding to the usage rules is verified, indicated at Block 160. If, however, the recalculated overall hash does not match the overall hash stored in the certificate or if the digital signature of the certificate is not valid, then the authenticity of the hash table is not verified, indicated at Block 162. Since the overall hash is the hashing of the hashes of each of the chunks stored in the hash table, and is not the hash of the actual content, it can be calculated very quickly. Moreover, hashing the hash table entries prevents would-be hackers from deleting, adding, rearranging, or otherwise changing the content chunks. Verification of the hash table 142 is also illustrated pictorially in Block diagram 170 of FIG. 8. First, the overall hash 148 of the hash table entries Hash(Chunk1), Hash(Chunk2), Hash(Chunk3), . . . , Hash(Chunk6) of hash table 142 is recalculated; this corresponds to Block 152 of FIG. 7. Since this hash is not over the entire content, it can be quickly calculated. Next, this overall hash must be checked to make sure that it agrees with the value in the certificate; this corresponds to Block 156 of FIG. 7. If the recalculated hash 148 agrees with the certificate hash value, then the hash table 142 and its binding to the usage rules are verified, as shown in Block 160 of FIG. 7.

The order of the above operations is not critical to practice of the invention. It is simply important that both verifications be performed. Therefore, it is just as valid to process Block 158 prior to performing the functionality of Blocks 152, 154, and 156. If the content passes both tests at Decision Blocks 156, 158, then its authenticity has been verified. If it fails either test at Decision Blocks 156, 158, then the content has failed the authenticity testing.

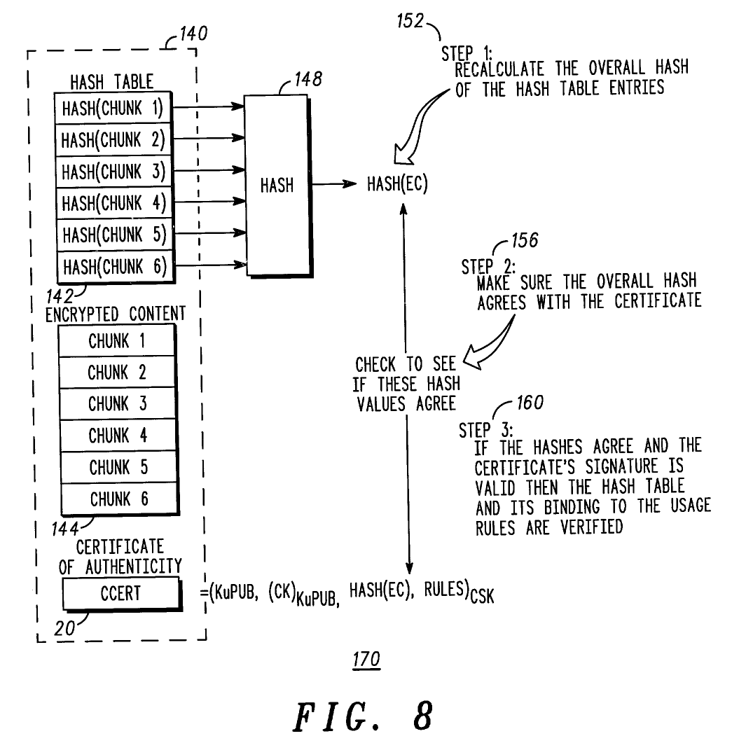

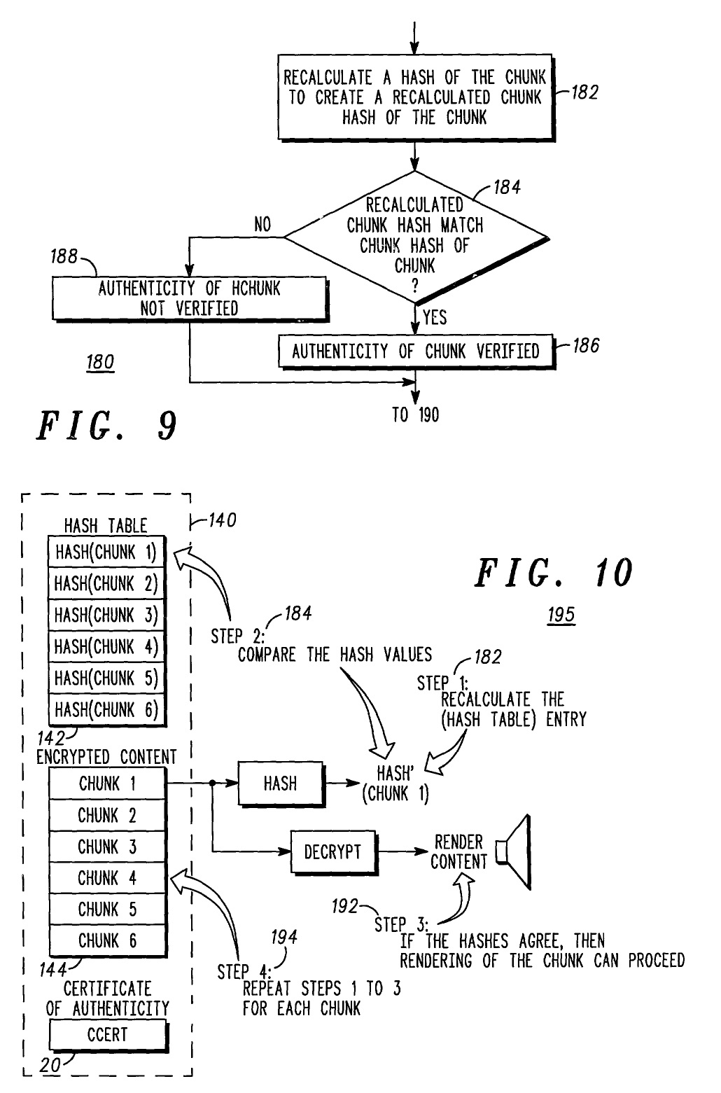

Upon the successful authentication of the hash table, the hash of the individual chunks can be verified; this corresponds to Blocks 180-194 of FIG. 4. Referring now to FIG. 9, verifying the authenticity of a chunk is illustrated. At Block 182, a hash of a selected chunk is recalculated to create a recalculated chunk hash of that chunk. At Decision Block 184, the inquiry is whether the recalculated chunk hash matches the previously calculated chunk hash of the chunk. If yes, then the authenticity of the chunk is verified at Block 186. If not, then the authenticity of the chunk is not verified. And, referring back to FIG. 4, upon authentication of a chunk, that chunk can be rendered immediately at Block 192 without the requirement that the hash of the entire content be performed a priori. Of course, decryption of the selected chunk can be performed at the same time that the chunk is being authenticated. In this way, rendering of the individual chunk can begin almost immediately. Also, it is noted that in a less secure implementation, one could also render a chunk prior to checking the hash and if the hash check fails, stop rendering all subsequent chunks.

Block diagram 195 of FIG. 10 presents a more pictorial representation of the verification flow of FIGS. 9 and 4. First, the hash table entry of a chunk, shown as Chunk1 in this example, is recalculated to yield a recalculated chunk hash Hash′(Chunk1); this corresponds to Block 182. Next, the recalculated chunk hash Hash′(Chunk1) is compared to the Chunk1 hash entry in hash table 142 to see if there is a match, as shown in Block 184. If the hashes agree, this indicates that the authenticity of a chunk is verified and rendering of the chunk can begin. Finally, this process is repeated for each chunk of the content.

It is noted that this process is independent of the type of data being hashed. If the data were unencrypted or not part of a content package, the same process would be applicable. The inventive concepts of chunking the data and creating a hash table are independent of the type of digital content being processed.

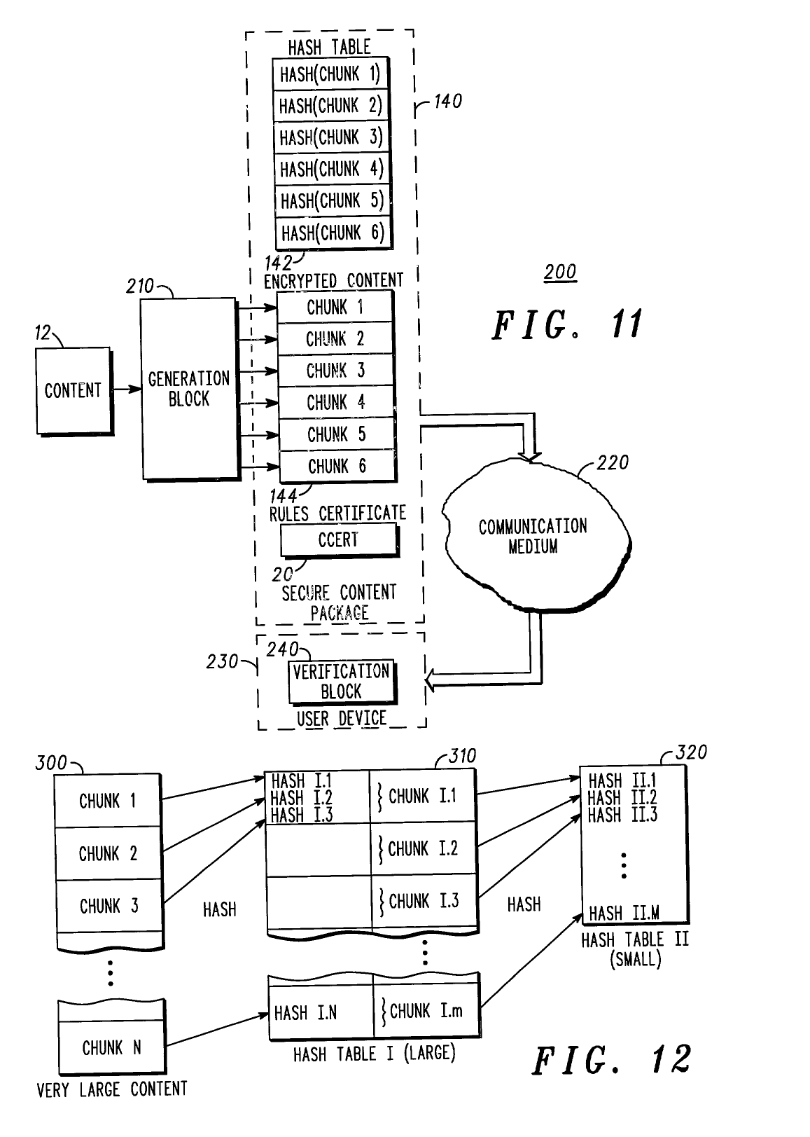

Block diagram 200 of FIG. 11 illustrates an exemplary system block diagram of the present invention. Generation block 210 is analogous to the functionality illustrated in Block 110 of FIG. 4, while verification block 240 is analogous to the functionality illustrated in Blocks 150-194 of FIG. 4. Content 12 is provided to generation block 210 where it is optionally encrypted and divided into chunks of content 144, which, together with hash table 142 and CCert certificate become part of secure content package 140. The chunked data content, together with hash table contents 142 and CCert 20 are provided to verification block 240 via some communication medium, such as a server or the Internet. Verification block 240 resides within or is coupled to a user device 230, such as a pager, a mobile phone, PCS device, BlueTooth device, an automotive entertainment system, set-top box, or home computer (PC), for instance. Verification block 240 contains the functionality needed to verify the authenticity of the hash table and, if appropriate, the authenticity of the individual chunks of content prior or subsequent to rendering. It is understood that the functionality of generation block 210 as well as verification block 240 may be implemented in hardware, firmware, software, or any other process capable of providing the disclosed functionality.

The present invention is applicable to protecting digital content, even extremely large content files such as video in which the hash table can be very large. In this situation, calculating even the overall hash of the hash table be quite time consuming. This situation, however, can be addressed by the present invention by subdividing the hash table into chunks that are each subsequently hashed in their own right and added to a secondary hash table, with each secondary hash table corresponding to a hash table chunk. The secondary hash tables are hashed as described above in conjunction with the chunks. This scheme uses multiple layers of hash tables and preferably a single certificate to authenticate all of the hash tables and the content.

One way of viewing this is to consider a hash table itself as input content to be processed by the method of the current invention. In this case, encryption of the content would not make sense, so that the content is hashed into a hash table without prior encryption. This process can be repeated as many times as necessary to get the final hash table down to a small enough size. Expanding the authentication for content with multiple hash table layers follows the same general pattern of authenticating the main hash table and then chunks of the smaller hash tables/content as required. Preferably, this is all performed concurrently with the rendering of the original content.

This approach is further illustrated in FIG. 12. The original content, in this case a very large content block 300 has been divided into a plurality of chunks Chunk1, Chunk2, Chunk3, . . . , Chunkn. Using the approach of the present invention, previously described above, these chunks are processed to produce a very large Hash Table I 310 with hash table entries Hashl.1, Hashl.2, Hashl.3, . . . . Hashl.n that can be stored as part of the content package. This is representative of the flow of Blocks 112-116 of FIG. 5. Since the size of Hash Table I 310 produced by the present invention is still prohibitively large, it can in turn be treated as content that is itself chunked and hashed in accordance with the present invention. Thus, the chunks of Hash Table I 310, Chunkl.1, Chunkl.2, Chunkl.3, . . . , Chunkl.m are hashed to produce Hash Table II 320. That is, Chunkl.1 consists of Hashl.1, Hashl.2, Hashl.3, . . . until a chunk is reached. This corresponds to repeating Blocks 114-116 of FIG. 5. Thus, the hash of Chunkl.1 is Hashll.1, the first entry in Hash Table II 320 and the hash of Chunkl.m is Hashil.m, the last entry in Hash Table II 320. In this example, Hash Table II is small enough to be completely hashed quickly, such as before rendering of content begins. The rest of the generation process that follows is as described above for the non-iterated approach in that the overall hash of Hash Table II 320 can be calculated (as in Block 118 of FIG. 5) and included in the certificate which can then be signed (Block 120 of FIG. 5). Again, chunking and hashing a hash table itself may be performed as often as needed to obtain the right size hash table suitable for allowing an adequately swift hashing process during the subsequent verification process outlined in Blocks 150-190 of FIG. 4.

The verification process of the iterated approach for this particular example is somewhat similar to the verification process set forth in FIG. 4. Hash Table 11 is hashed to provide a recalculated value which can then be checked against the previously calculated and expected value stored in the signed certificate. If there is a match, the process continues. Next, the first chunk of Hash Table I, Chunkl.1, is hashed and its hashed value is compared against the expected and corresponding value stored in Hash Table II. If there is a match, then the first chunk of content is hashed. This hash value then is compared with the expected and corresponding value Hashl.1 in Hash Table I, Chunkl.1. If they match, the first chunk of content is authenticated and can be rendered. The next step is to hash the second chunk of content and compare it with the value Hashl.2 in Hash Table I. The process continues for each chunk of content and each chunk of Hash Table I.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims. For instance, it is noted that the present invention is applicable to portable, wireless devices such as pagers, mobile phones, PCS devices, and BlueTooth devices characterized as having a limited communication range, as well as to devices that are not necessarily mobile or wireless, such as automotive entertainment systems, set-top boxes that handle digital content, and home computers.

What is claimed is:

1. A method of creating a signed content hash, comprising:
dividing content into a plurality of chunks of content;
hashing each chunk of the plurality of chunks of content into a hash table; and
signing the hash table.

2. The method of claim 1, wherein hashing each chunk of the plurality of chunks of content into the hash table comprises:
calculating a chunk hash of each chunk of the plurality of chunks of content to provide a plurality of chunk hashes corresponding to the plurality of chunks of content; and
storing the plurality of chunk hashes in the hash table.

3. The method of claim 1, wherein dividing the content into the plurality of chunks of content and hashing each chunk of the plurality of chunks of content into the hash table is repeated a plurality of times to create a corresponding plurality of hash tables.

4. The method of claim 1, wherein signing the hash table comprises:
creating a certificate of authenticity of the hash table; and
signing the certificate of authenticity of the hash table.

5. The method of claim 4, wherein the certificate of authenticity of the hash table comprises the hash table in its entirety.

6. The method of claim 4, wherein the certificate of authenticity of the hash table comprises an overall hash of the hash table.

7. The method of claim 6, wherein creating the overall hash of the hash table comprises:
hashing the plurality of chunk hashes stored in the hash table to create the overall hash of the hash table.

8. The method of claim 4, wherein the certificate of authenticity of the hash table comprises additional information relating to the content and a set of rules governing the use of the content.

9. A method of authenticating a content hash, comprising:
authenticating a hash table containing a plurality of chunk hashes corresponding to a plurality of chunks of content;
dividing the content into a plurality of chunks of content; and
authenticating each chunk of the plurality of chunks of content.

10. The method of claim 9, wherein authenticating the hash table comprises:
verifying a certificate of authenticity of the hash table; and
if the certificate of authenticity of the hash table is verified, authenticating the hash table.

11. The method of claim 10, wherein verifying the certificate of authenticity of the hash table comprises:
verifying a signature of the certificate of authenticity comprising the hash table in its entirety; and
if the signature of the certificate of authenticity containing the hash table in its entirety is verified, verifying the authenticity of the hash table.

12. The method of claim 10, wherein verifying the certificate of authenticity of the hash table comprises:
verifying a signature of the certificate of authenticity comprising an overall hash of the hash table;
calculating a recalculated overall hash of the hash table; and
if the recalculated overall hash of the hash table matches the overall hash of the hash table, verifying the authenticity of the hash table.

13. The method of claim 12, wherein calculating the recalculated overall hash of the hash table comprises:
hashing the plurality of chunk hashes stored in the hash table to create the recalculated overall hash of the hash table.

14. The method of claim 10, wherein verifying the certificate of authenticity of the hash table further comprises:
verifying additional information in the certificate of authenticity of the hash table relating to the content and a set of rules governing the use of the content.

15. The method of claim 9, wherein authenticating each chunk of the plurality of chunks of content comprises:
calculating a recalculated chunk hash of the chunk of content to provide a recalculated chunk hash corresponding to the chunk of content;
comparing the recalculated chunk hash to the chunk hash of the chunk stored in the hash table; and
if the recalculated chunk hash matches the chunk hash of the chunk stored in the hash table, verifying the authenticity of the chunk.

16. The method of claim 15, further comprising:
processing the chunk of content by having the recalculated chunk hash of the chunk of content calculated concurrently with calculating the recalculated chunk hash of the chunk.

17. The method of claim 16, wherein processing the chunk of content further comprises:
decrypting the chunk of content; and
rendering the chunk of content to the user.

18. The method of claim 9, wherein dividing the content into the plurality of chunks of content and authenticating each chunk of the plurality of chunks of content is repeated a plurality of times to authenticate a corresponding plurality of hash tables.

19. A method of authenticating digital content, comprising:
calculating an overall hash of a hash table containing a plurality of chunk hashes corresponding to a plurality of chunks of content;
comparing the overall hash of the hash table to a hash contained in a certificate; and
if the overall hash of the hash table matches the hash of the certificate, verifying the authenticity of the plurality of chunks of the content.

20. The method of claim 19, wherein verifying the authenticity of the plurality of chunks if the overall hash of the hash table matches the hash of the certificate, further comprises for each chunk of the plurality of chunks of content:
calculating a hash of the chunk to create a chunk hash of the chunk;
comparing the chunk hash to a stored chunk hash of the chunk stored in the hash table; and
if the chunk hash matches the stored chunk hash, verifying the authenticity of the chunk.

21. The method of claim 20, wherein contemporaneously with calculating the hash of the chunk to create the chunk hash of the chunk, further comprising:
decrypting the chunk to provide a chunk of decrypted content of the content package; and
rendering the chunk of decrypted content of the content package.

22. A method of authenticating digital content, comprising:
dividing content of a content package into a plurality of chunks of content;
calculating a chunk hash of each chunk of the plurality of chunks of content to provide a plurality of chunk hashes stored in a hash table corresponding to the plurality of chunks of content;
hashing the plurality of chunk hashes of the hash table to create an overall hash of the content of the content package;
placing the overall hash into a certificate;
determining whether a recalculated overall hash of the hash table matches the overall hash of the hash table;
if the recalculated hash of the hash table matches the overall hash of the hash table, verifying the authenticity of each chunk of the plurality of chunks of the content.

23. The method of claim 22, wherein determining whether the recalculated overall hash of the hash table matches the overall hash of the hash table comprises:
recalculating the overall hash of the hash table to create the recalculated overall hash;
comparing the recalculated overall hash to the overall hash; and
if the recalculated overall hash matches the overall hash and a signature on the certificate is valid, verifying authenticity of the hash table.

24. The method of claim 22, wherein verifying the authenticity of each chunk of the plurality of chunks comprises for each chunk:
recalculating a hash of the chunk to create a recalculated chunk hash of the chunk;
comparing the recalculated chunk hash to the chunk hash of the chunk; and
if the recalculated chunk hash matches the chunk hash of the chunk, verifying the authenticity of the chunk.

25. The method of claim 24, wherein contemporaneously with recalculating the hash of the chunk to create the recalculated chunk hash of the chunk, further comprising:
decrypting the chunk to provide a chunk of decrypted content of the content package; and
rendering the chunk of decrypted content of the content package.
